(19) United States
(12) Patent Application Publication
(10) Pub. No.: US 2010/0236475 A1
(43) Pub. Date: Sep. 23, 2010

(54) POSITIONABLE MASKING ARTICLE

(75) Inventor: Joseph T. Bartusiak, Osseo, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/725,861

(22) Filed: Mar. 17, 2010

Related U.S. Application Data
(60) Provisional application No. 61/161,242, filed on Mar. 18, 2009.

(51) Int. Cl. B05C 11/00

(52) U.S. Cl. 118/505

(57) ABSTRACT

A masking article includes a bendable backing layer having first and second opposed major surfaces, an adhesive arranged on at least a portion of at least one of the first and second major surfaces, wherein the adhesive has a thickness, and a raised element arranged on the same major surface as the adhesive, wherein the raised element extends beyond the thickness of the adhesive such that the masking article can be moved along an application surface to a desired location without having the adhesive adhere to the application surface, and such that the masking article can be secured to the application surface by pressing the backing layer in the region opposite the adhesive, thereby forcing the adhesive into contact with the application surface to secure the masking article to the application surface at the desired location.

### BACKGROUND

This application claims the benefit of U.S. Provisional Patent Application No. 61,161,242, filed Mar. 18, 2009, the disclosure of which is incorporated by reference herein in its entirety.

The present invention relates generally to paint masking and, more particularly, to a sheet-like adhesive article that can be selectively secured to a mounting surface by a pressure sensitive adhesive. More particularly, the present invention relates to an adhesive article, such as a paint masking sheet assembly, that can be manually slid across a mounting surface and, once properly positioned, easily secured in place by manually pressing the article against the mounting surface.

When painting or staining a surface, care must be taken so that the paint does not get on the surfaces adjacent the area to be painted. This can be accomplished by carefully painting the surface, or by masking off the area around the area to be painted. To facilitate the masking process, masking tape articles having specific sizes and shapes tailored to specific masking applications have been developed.

Paint masking articles are known in the prior art. U.S. Pat. No. 6,579,587 (Schnoebelen, Jr.), for example, discloses a paint mask for masking corners. The paint mask if formed of a thin, flexible sheet having opposite faces. The paint mask includes a first leg and a second leg that are generally rectangular in shape, and the legs intersect to form a right angle adapted for masking a corner adjacent an area. U.S. Pat. No. 6,852,408 (Hansen et. al.) discloses a masking device including a substantially rigid body, the body having an underside and adjoining first and second edges and an adhesive portion positioned on the underside adjacent to one or more of the first and second edges.

The need exists for an inexpensive masking article that is lightweight, easy to make, and easy to use. In particular, the need exists for a masking article that can be accurately positioned at a selected location prior to securing it to the surface to be masked.

### SUMMARY

Windows are often masked to keep the window glass from being splattered with paint, and to create sharp clear paint lines. Conventional techniques, such as taping, tend to be very time consuming, taking as much as half the time for the total painting project. The present invention addresses this problem in that it provides a faster, easier, and more accurate technique for masking windows for painting, especially small windows.

In one embodiment, the present invention provides a masking article including a bendable backing layer having first and second opposed major surfaces, an adhesive having a defined thickness arranged on at least a portion of at least one of the first and second major surfaces, and a raised element arranged on the same major surface as the adhesive, wherein the raised element extends beyond the thickness of the adhesive such that the masking article can be moved along an application surface to a desired location without having the adhesive adhere to the application surface, and further such that the masking article can be secured to the application surface by pressing the backing layer in the region opposite the adhesive, thereby forcing the adhesive into contact with the application surface to secure the masking article to the application surface at the desired location.

In another aspect, the present invention provides a masking sheet having a base substrate layer having a front side and an opposite back side. The front side of the substrate allows paint to adhere to it. A securing mechanism is arranged on the back side of the substrate layer. The securing mechanism includes a raised element and a pressure sensitive adhesive. The adhesive may be disposed between the raised element and the backside of the substrate layer. The pressure sensitive adhesive has an exposed surface along at least a portion of the perimeter edge of the back side of the substrate. The height of the adhesive, as measured from its exposed surface to the front side of the substrate is shorter than the height of the raised element, as measured from its application surface to the front side of the substrate. The thickness of the raised element, stiffness of the substrate material, and exposed surface area prevents the adhesive from contacting and/or adhering to a surface abutting the back side of the substrate layer in the absence of the application of pressure against the outer edges of the front side of the substrate layer.

When the masking sheet has its back side surface abutting another surface, such as another masking sheet, it will not adhere thereto because the pressure sensitive adhesive thereon is spaced from that surface. The unattached sheets can then be stacked like a deck of playing cards for easy transportation and use. When pressure is applied to the front side of the substrate opposite the pressure sensitive adhesive thereon, the sheet bearing the adhesive is sufficiently flexible and deformable so that at least a portion of the exposed adhesive is brought into contact with an adjacent surface. In this manner, a plurality of sheets may be formed into a pad. The plurality of sheets may also be attached together to form a pad or roll using various means.

### BRIEF DESCRIPTION OF THE DRAWINGS

FIG. 1 is a perspective top view of a stack masking articles according to the invention.

FIGS. 2A is a perspective bottom view of a stack of masking articles according to the invention.

FIG. 2B is an exploded perspective bottom view of a stack of masking articles.

FIG. 3 is a bottom plan view of a single sheet in the stack of FIG. 2B.

FIG. 4 is a sectional view taken along line 4-4 of FIG. 3.

FIG. 5 is a sectional view of a plurality of unattached sheets in a stack of the present invention.

FIG. 6 is a sectional view of another embodiment of the invention showing a release layer.

FIG. 7A is a top perspective view of FIG. 6.

FIG. 7B is a perspective view of a variation on the embodiment of FIG. 6.

FIG. 8A is a bottom perspective view of FIG. 6 as viewed from the opposite side of either FIG. 7A or 7B.

FIG. 8B is a bottom perspective view of a variation of the embodiment of FIG. 6.

FIG. 9 is a sectional view of a pad of sheets.

FIGS. 10A-D are bottom plan views of FIG. 3, showing raised elements having various designs.

FIG. 11 is a perspective top view of another embodiment of the invention showing a pad of attached sheets.

FIG. 12 is a bottom plan view of a single sheet in the pad of FIG. 11.

FIG. 13 is a perspective view of another embodiment of the invention showing unattached sheets on a release liner.

FIGS. 14A and 14B are perspective views of another embodiment of the invention showing sheets in roll form in which individual sheets are separated at perforation lines (FIG. 14A), or dispensed using a cutting blade (FIG. 14B).

FIGS. 15A and 15B are sectional side views showing the adhesive article being applied to a window pane.

FIG. 16 is a diagrammatic plan view showing a single sheet being slid across a window pane, and into the corner of the window.

FIG. 17 is a perspective plan view of the invention showing four masking sheets covering glass in a window frame.

FIG. 18 is a plan view of another embodiment of the invention.

FIGS. 19A-19C are perspective views of another embodiment of the invention showing the release liner acting as the raised element.

FIG. 20A is a sectional view taken along line 20A-20A of FIG. 19B.

FIG. 20B is a sectional view taken along line 20B-20B of FIG. 19C.

### DETAILED DESCRIPTION

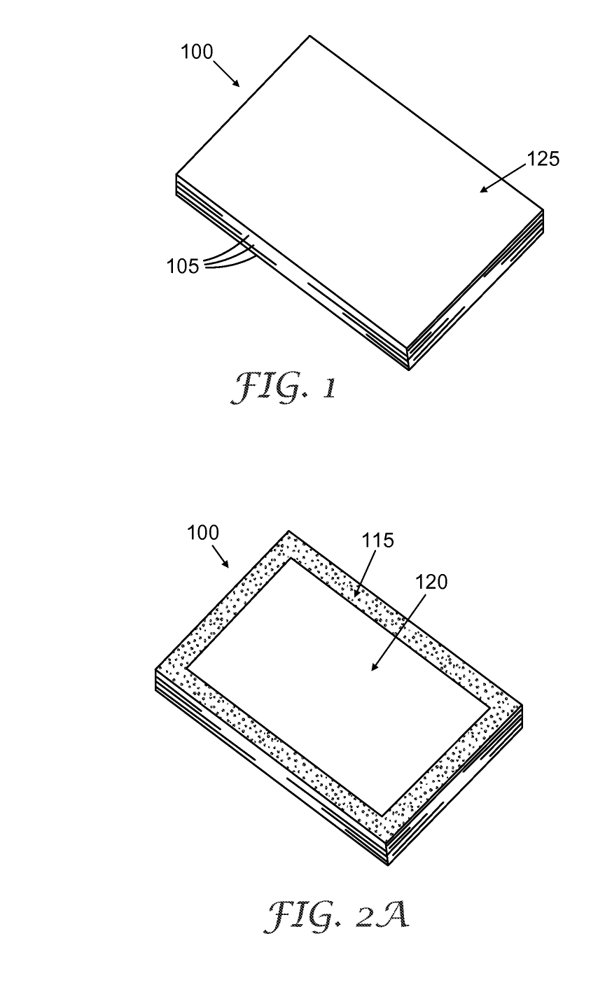

FIG. 1 is a perspective top view of a stack 100 of masking articles or sheets 105 according to one embodiment of the invention. The stack 100 includes a plurality of individual sheets 105, which may be loosely arranged (i.e. not connected, affixed, or attached to each other) to form a stack similar to a deck of playing cards, or the individual sheets may be connected or affixed to form a pad of sheets. As explained in greater detail below, each sheet 105 includes a substrate 125, and a securing mechanism.

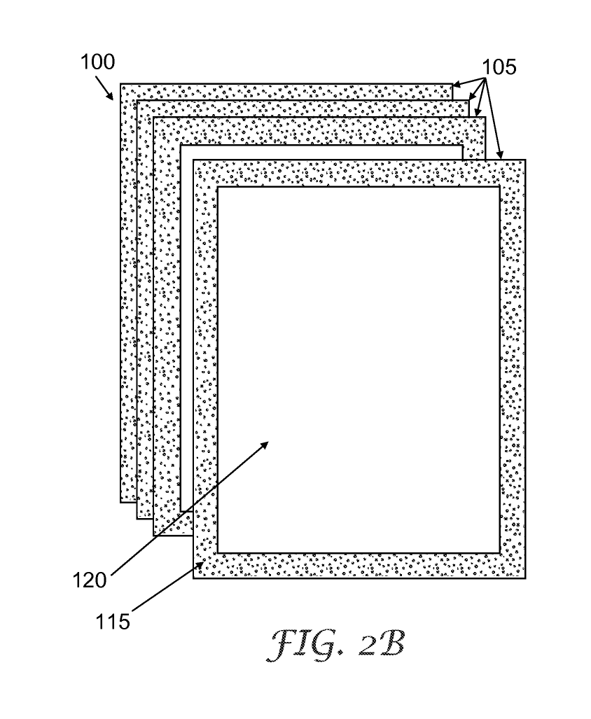

FIG. 2A is a perspective bottom view of the stack 100. That is, FIG. 2A is similar to FIG. 1 except the stack 100 has been flipped over to show the securing mechanism, which includes a raised element 120 and a pressure sensitive adhesive 115.

FIG. 2B is similar to FIG. 2A, and shows the stack 100 with the plurality of sheets 105 not attached to each other. That is, the individual sheets 105 can be readily moved relative to each other. A stack 100 of individual sheets 105 is a convenient way of transporting and handling.

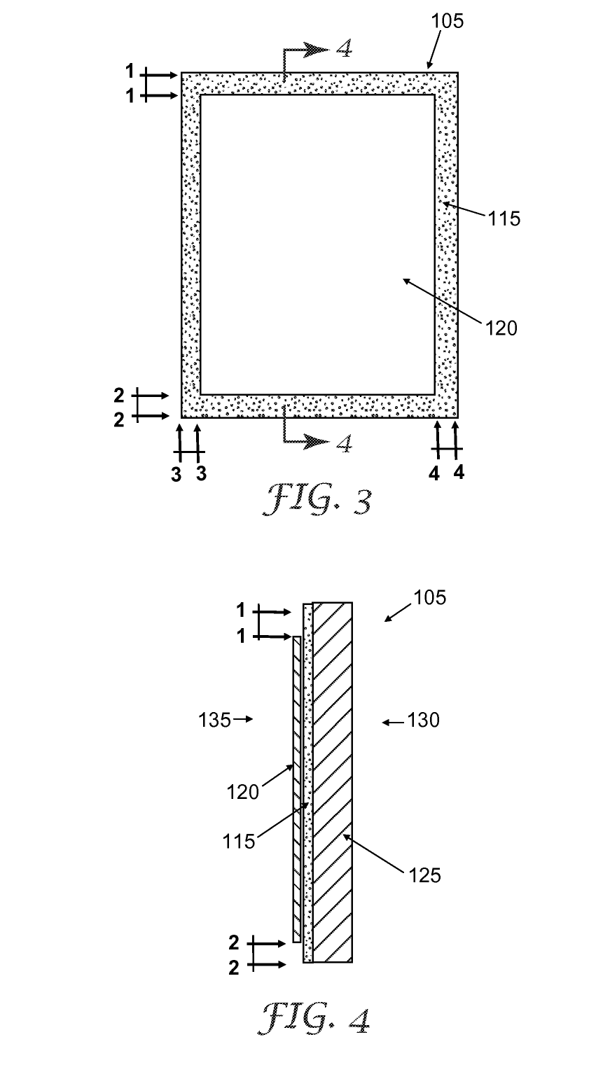

FIG. 3 is a bottom plan view of an individual sheet 105. In the illustrated embodiment, the bottom surface of the sheet 105 includes a pressure sensitive adhesive 115 arranged along the entire perimeter edge of the substrate 125 (FIG. 4), and a raised element 120 arranged on a central region of the sheet 105. It will be recognized that the configuration of the pressure sensitive adhesive 115 and the raised element 120 is not critical, so long as it allows the masking article 105 to be slid across a surface to a desired location by a user, and then affixed at the selected position by pressing the masking article against the surface. For example, the pressure sensitive adhesive 115 may be arranged along only selected portions of the perimeter edge region of the substrate 125, or the raised element 120 may be provided along the perimeter edge region of the substrate 125, and the pressure sensitive adhesive 115 may be provided on a selected interior (or regions) of the substrate.

In the illustrated embodiment, the pressure sensitive adhesive 115 is disposed between raised element 120 and base substrate 125 (FIG. 4). That is, the pressure sensitive adhesive 115 is a continuous coating on the back side of substrate 125. The raised element 120 is arranged directly on top of pressure sensitive adhesive 115 except for along edges 1-1, 2-2, 3-3, and 4-4. The raised element 120 may be a coating layer coated over the pressure sensitive adhesive 115 that serves to detackify the pressure sensitive adhesive 115, or the raised element 120 may be, for example, a film layer arranged over the pressure sensitive adhesive 115.

In various embodiments, the exposed adhesive regions, such as edges 1-1, 2-2, 3-3, and 4-4, may have a width of at least about 1 millimeters (mm), at least about 2 mm, at least about 3 mm, or at least about 4 mm, and a width of no greater than about 16 mm, no greater than about 14 mm, no greater than about 12 mm, and no greater than about 10 mm. It has been found that, depending on the type of adhesive 115 used and depending on the height of the raised element 120, adhesive regions having widths less than about 3 mm may have difficulty staying adhered to an application surface. In addition, it has been found that adhesive regions having widths greater than about 13 mm may have difficulty sliding across the application surface. In one specific embodiment, the adhesive regions are perimeter edge regions, and the adhesive edges have a width of from about 4 mm to about 9 mm.

FIG. 4 is a cross-sectional view of the sheet 105 of FIG. 3. The sheet 105 includes a base layer or substrate 125, and a securing mechanism including a pressure sensitive adhesive 115 and a raised element 120. The sheet 105 has a top side 130 and a bottom side 135. The top side 130 may also be referred to as the paint adhering side. The bottom side 135 may also be referred to as the application side. Exposed adhesive edges 1-1 and 2-2 are also shown in FIG. 4.

FIG. 5 shows a cross-sectional view of a plurality of sheets 105a-d stacked, but not attached. Raised elements 120a-d serve to (i) overlay and detackify the pressure sensitive adhesive 115a-d except for edges 1-1, 2-2, 3-3, and 4-4 as seen in FIG. 3, and (ii) provide a thickness 140a-d to prevent the pressure sensitive adhesive 115a-d from contacting a surface abutting the back side of the substrate layers in the absence of a force sufficient to otherwise cause the pressure sensitive adhesive edges 1-1, 2-2, 3-3, and 4-4 to contact the back side of the adjacent substrate layer.

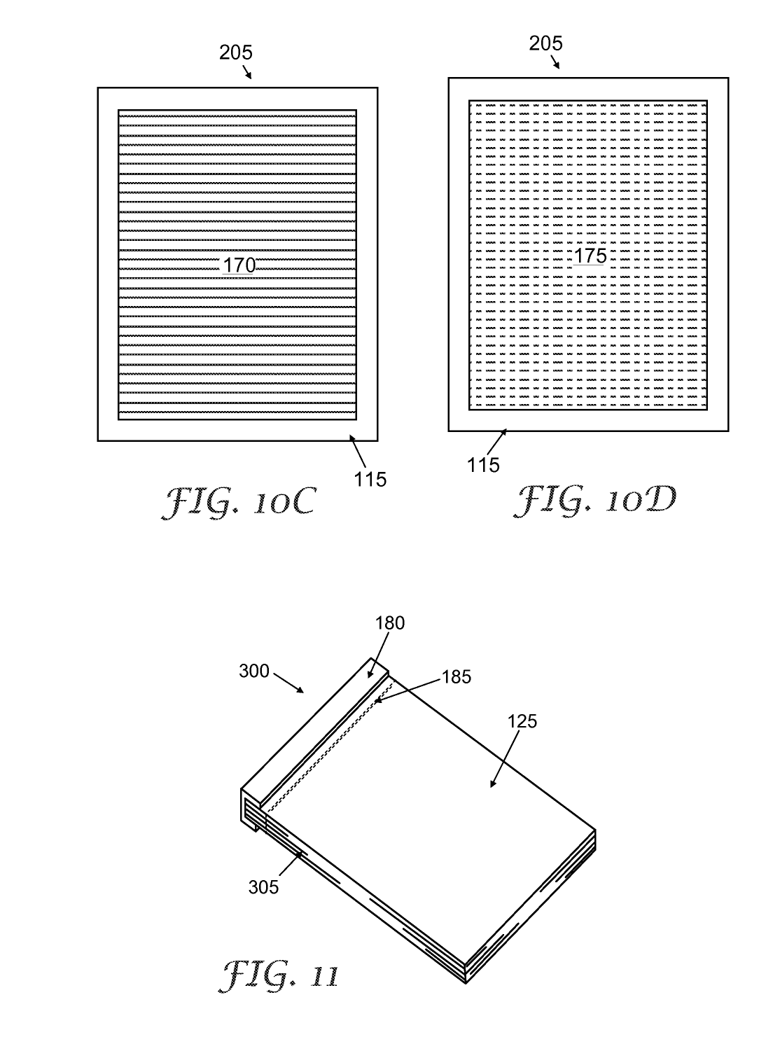

In certain embodiments, the raised element 120 may have a thickness of at least about 0.005 mm, at least about 0.01 mm, or at least about 0.02 mm, and a thickness of no greater than about 0.4 mm, no greater than about 0.35 mm, or no greater than about 0.3 mm. In this manner, the raised element 120 allows the individual unattached sheets 105 to be easily slide over each other, similar to a deck of playing cards. Raised element 120 also allows sheet 105 to slide across an application surface without adhering to the application surface (in the absence of the application of pressure against the adhesive outer edges of the front side of the substrate layer sufficient to cause the adhesive outer edges to contact the application surface). Although FIG. 5 shows a single raised element, in some embodiments, two or more raised elements may be provided, as shown and further described, for example, in FIGS. 10A-D.

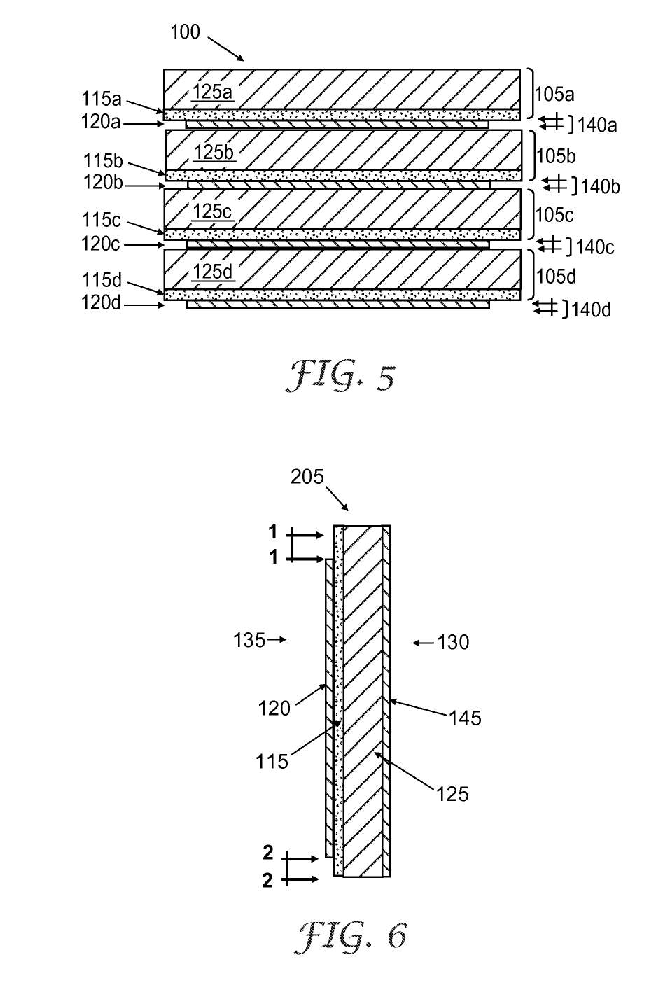

FIG. 6 is a sectional view of another embodiment of the present invention. Sheet assembly 205 has a base substrate 125, a release coating layer 145, and a securing mechanism including a pressure sensitive adhesive 115 and a raised element 120. FIG. 6 is similar to FIG. 4 except release layer 145 is coated on the front side of substrate 125. Release layer 145 allows pressure sensitive adhesive 115 to be easily removed from the front side of substrate 125 if stacked and pressure is applied against the outer edges of the front side of substrate 125.

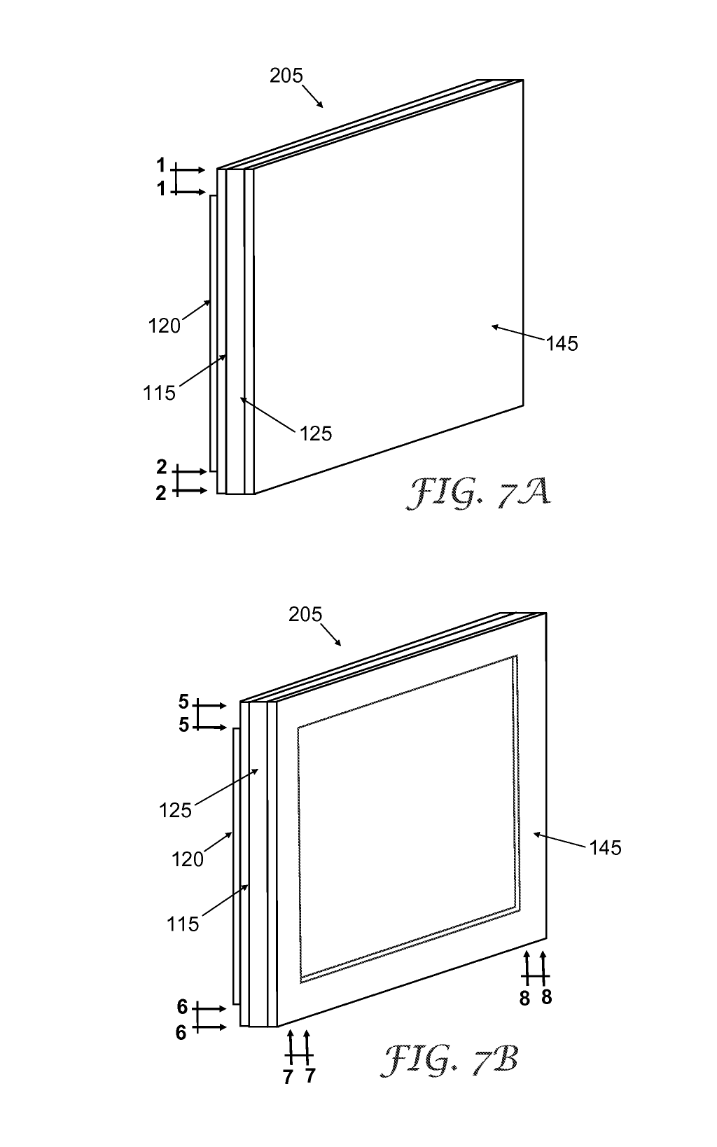

FIG. 7A is the top perspective view of FIG. 6. As illustrated, the release coating 145 is coated over the entire front side of substrate 125. The release coating 145 allows exposed adhesive edges 1-1, 2-2, 3-3, and 4-4 (as shown in FIG. 3 and partially shown in FIG. 7A) of pressure sensitive adhesive 115 to be easily removed from the front side of substrate 125 if stacked and pressure is applied against the outer edges of the front side of substrate 125.

FIG. 7B is a bottom perspective view of a variation of the embodiment shown in FIG. 6. In this embodiment, release coating 145 is coated on the front side of substrate 125 along perimeter edges 5-5, 6-6, 7-7, and 8-8. Release coating 145 allows exposed pressure sensitive adhesive 115 edges 1-1, 2-2, 3-3, and 4-4 (as shown in FIG. 3) to easily remove from the front side of substrate 125 if stacked and pressure is applied against the outer edges of the front side of substrate 125. In order to provide tolerances for misalignments of the sheet assembly when sheets are stacked, release coating edges 5-5, 6-6, 7-7, and 8-8 are coated wider than the adhesive edges 1-1, 2-2, 3-3, and 4-4.

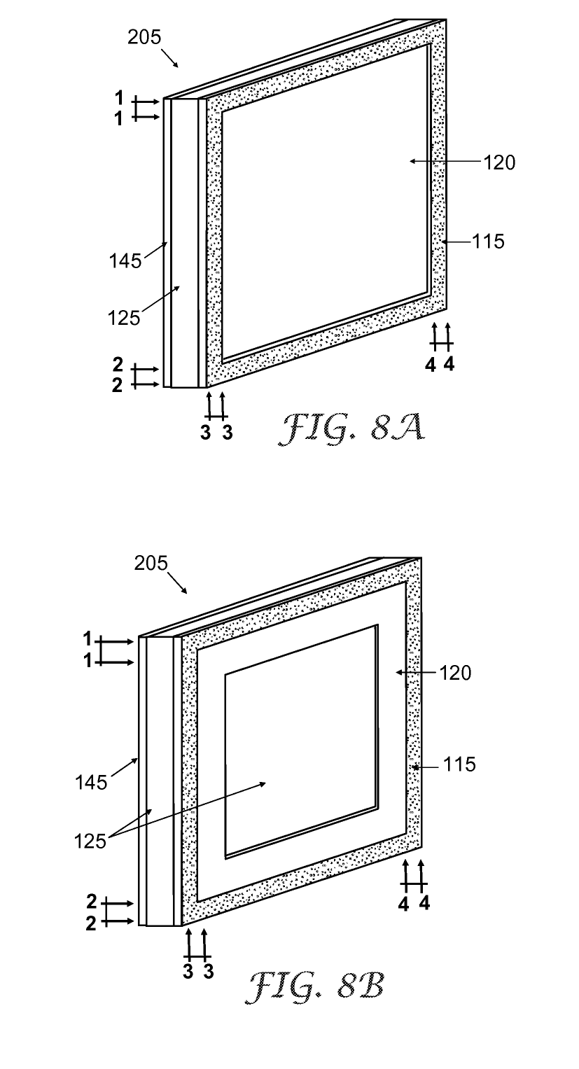

FIG. 8A is a bottom perspective view of a variation of the embodiment illustrated in FIG. 6, as viewed from the opposite side of either FIGS. 7A or 7B, showing raised element 120 as a solid square.

FIG. 8B is a bottom perspective view of another variation of the embodiment illustrated in FIG. 6, as viewed from the opposite side of either FIGS. 7A or 7B, showing the raised element 120 as a hollowed square. That is, the raised element 120 does not cover the interior region of the sheet 205, thereby leaving the substrate 125 exposed in the interior region of the sheet 205.

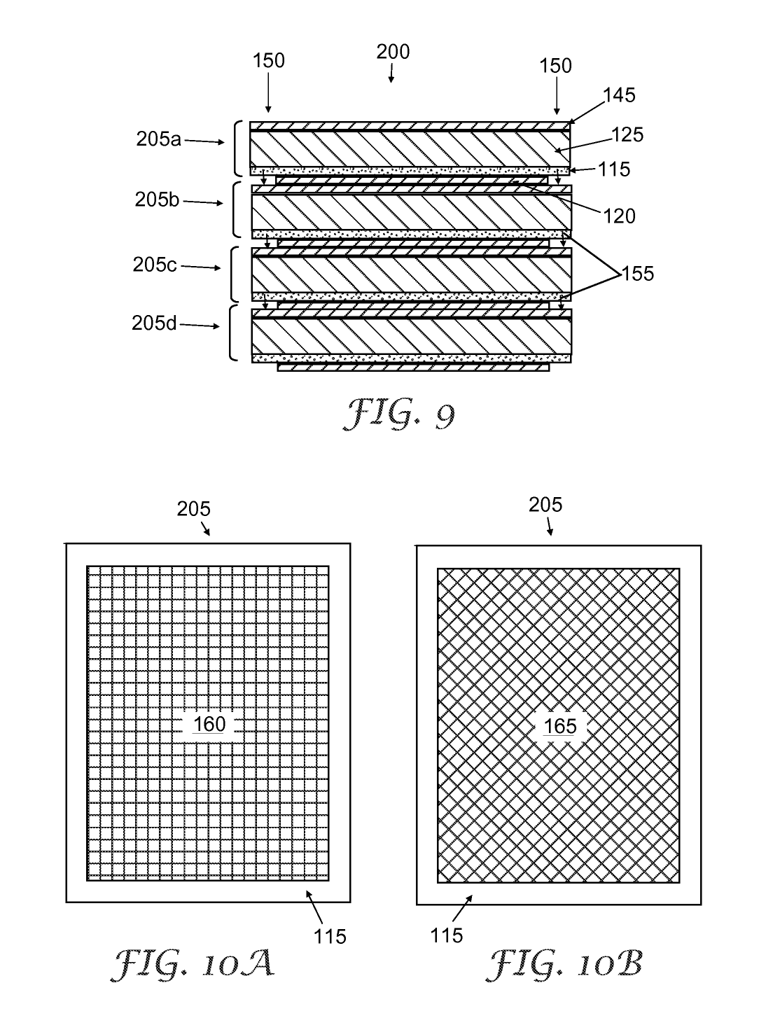

FIG. 9 is a cross-sectional view of a plurality of sheets 205a-d, as seen in FIG. 6, stacked together to form a pad. Pad 200 includes a plurality of sheets 205a-d stacked together in which sheet 205a attaches to sheet 205b, and sheet 205b attaches to sheet 205c, and so on, to form a pad when pressure 150 is applied to adhesive edges 1-1, 2-2, 3-3, and 4-4 (as shown in, for example, FIG. 8B) of the front side along release coating edges 5-5, 6-6, 7-7, and 8-8 (as shown in, for example, FIG. 7B) of the substrate 125 of sheet 205a. Substrate 125 bearing the adhesive is sufficiently flexible and deformable so that at least a portion of the exposed adhesive along edges 1-1, 2-2, 3-3, and 4-4 are brought into contact with the surface to adhere thereto, and so on. When an individual sheet 205a-d is needed, release layer 145 allows the sheet 205a-d to be peeled away from pad along edges with exposed pressure sensitive adhesive 120.

FIGS. 10A-D show several variations for the embodiment illustrated in FIG. 3. In particular, FIGS. 10A-D showing various designs for the raised elements 160, 165, 170, 175. In each of the illustrated embodiments, the sheets 205 are shown with various designs of two or more raised elements 160, 165, 170, 175. FIG. 10A shows raised element 160 in a grid pattern. FIG. 10B shows raised element 165 in a solid diamond pattern. FIG. 10C shows raised element 170 in a horizontal line pattern. FIG. 10D shows raised element 175 in a dashed horizontal pattern. The spacing between raised elements can range from about 2.0 inches or less to allow the sheet to adhere to the application surface but still allow the sheet to slide across an application surface without adhering in the absence of the application of pressure against the front side of the substrate layer. As shown in the diagrams, exposed pressure sensitive adhesive 115 perimeter edges still exist.

FIG. 11 is a perspective view of another embodiment of the invention. Pad 300 includes a plurality of sheets 305 stacked and attached together at end 180. Each individual sheet in the pad 300 may include a perforation 185 proximate to end 180. The securing mechanism of sheet 125 may be similar to sheets in stack 100 described in reference to FIG. 1.

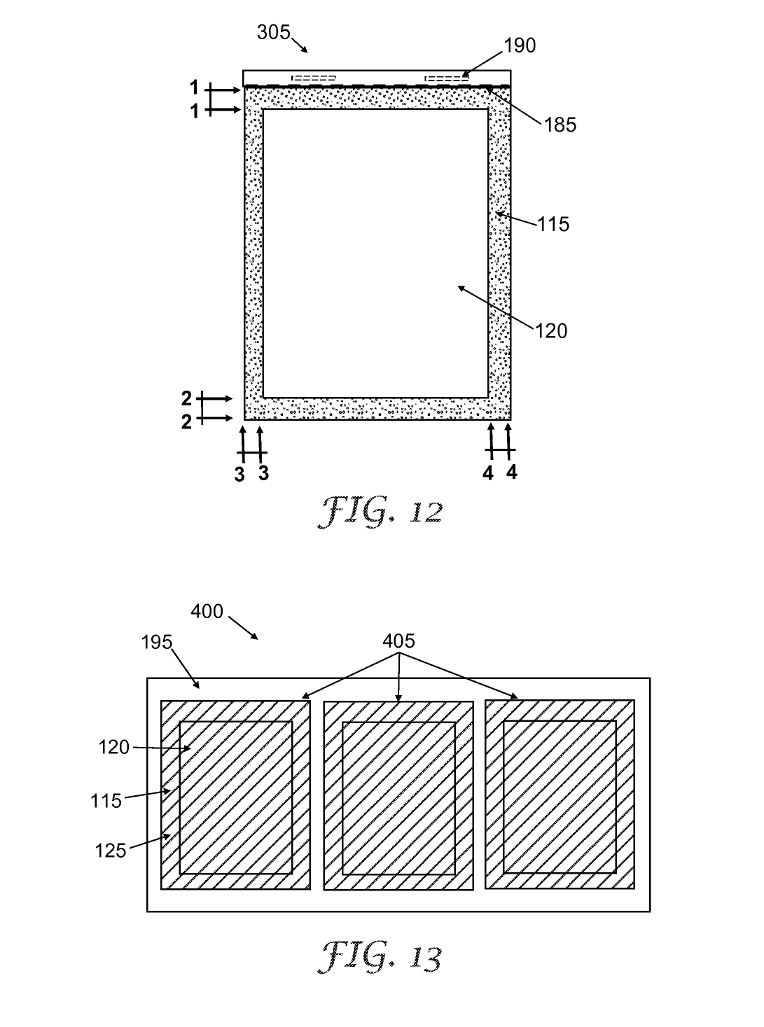

FIG. 12 shows a bottom plan view of one sheet 305 of pad 300. The sheets in the pad are attached together using mechanical means, such as staples 190. The sheet assembly is functionally similar to sheets in stack 100, FIG. 1.

FIG. 13 is a perspective view of another embodiment of the present invention. In this embodiment, individual sheets 405 are attached to release liner 195 at adhesive edges 1-1, 2-2, 3-3, and 4-4, as referenced in FIG. 3. Individual sheets 405 are detached from the release liner 195 by peeling the sheet off the liner. Assembly 400 may be in roll format or long sheet format (one long sheet may contain several individual masking sheets). Each masking sheet is functionally similar to sheets in stack 100, FIG. 1.

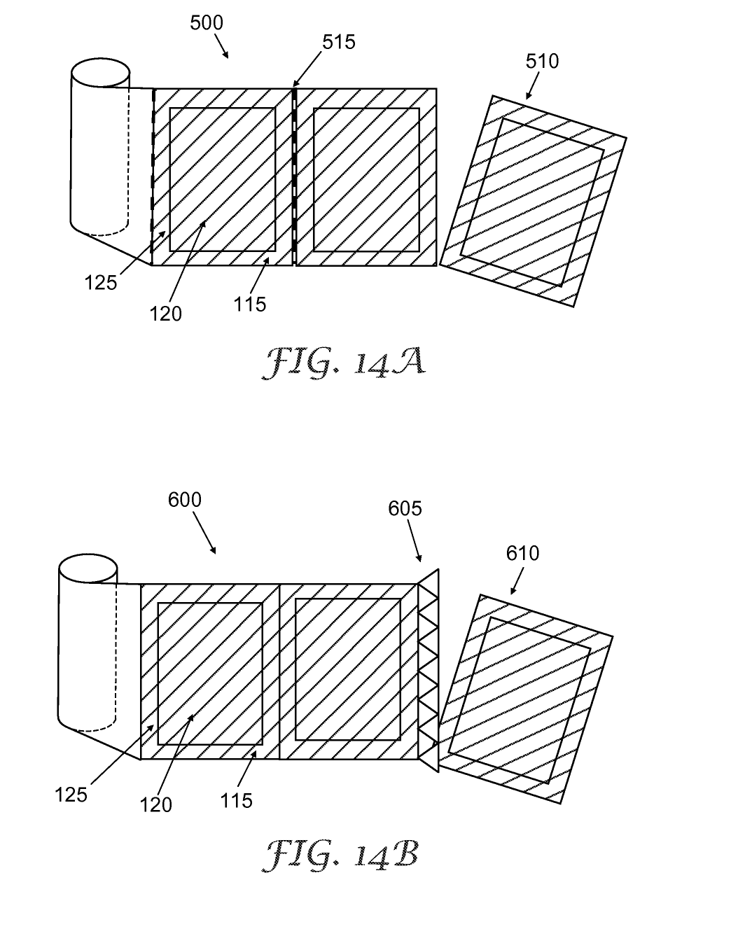

FIG. 14A is a perspective view of another embodiment of the present invention. In this embodiment, individual sheets 510 are manually separated from roll 500 at perforation 515. Each sheet assembly is functionally similar to sheets in stack 100, FIG. 1.

FIG. 14B is a perspective view of another embodiment of the present invention. In this embodiment, individual sheets 610 are manually dispensed on a cutting blade 605 from roll 600. Each sheet assembly is functionally similar to sheets in stack 100, FIG. 1.

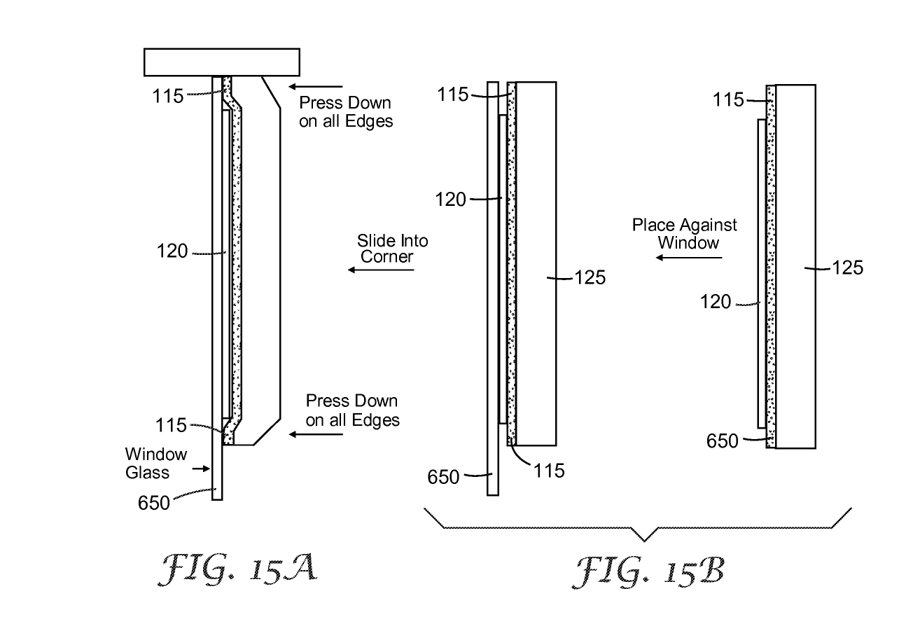

FIG. 15A-C show a cross-sectional view of a sheet assembly that allows the masking sheet to manually slide across a mounting surface, such as a window 650, and when properly aligned into position, easily secure the sheet in place by pressing against the substrates outer edges of the front side of the substrate layer with fingers.

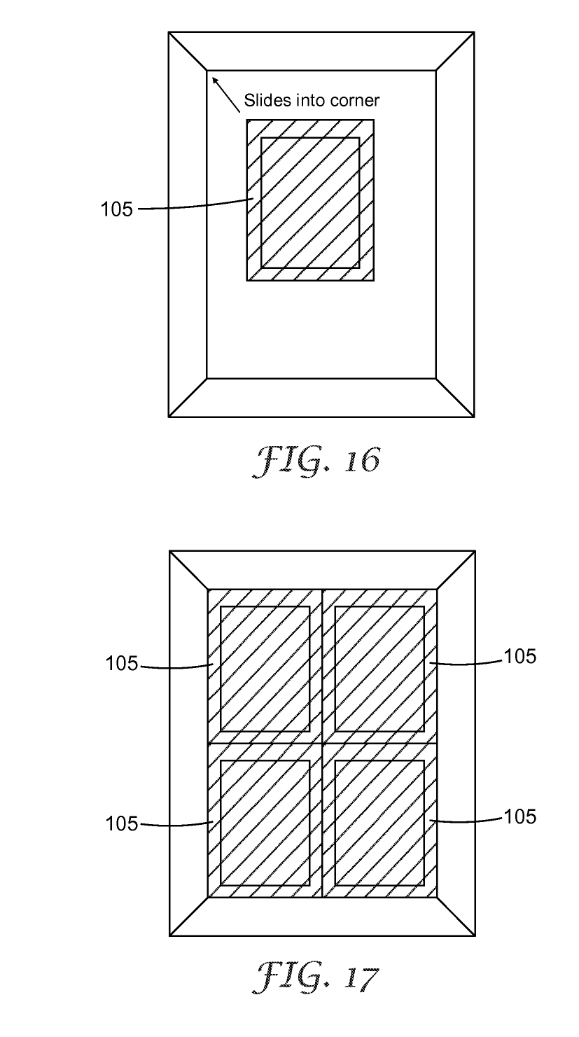

FIG. 16 is a plan view of the invention showing a single sheet being slid across window glass into a corner of the window.

FIG. 17 is a plan view of the invention, showing four masking sheets covering the glass in a window frame.

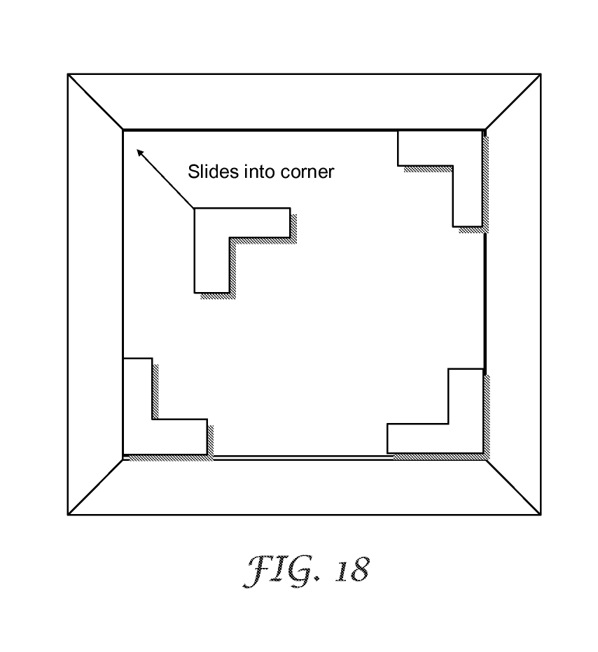

FIG. 18 is a plan view of another embodiment of the present invention showing masking articles having an L-shape being used to mask the four corners of a window pane. It will be recognized that the adhesive article can be formed into any desirable size or shape, depending on the end use application. Regardless of the size or shape, the masking article may have a function and construction similar to those described herein.

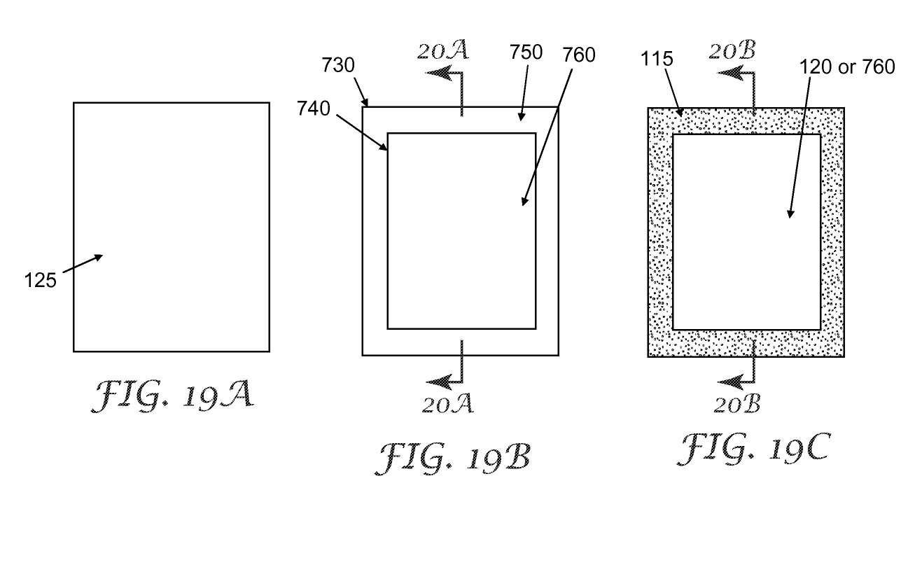

FIGS. 19A-19C are plan views of another embodiment of the present invention wherein a release liner 730 acts as the raised element 120. FIG. 19A shows base substrate 125. FIG. 19B is the opposite side of FIG. 19A showing release liner 730 with die cut area 740. Release liner 730 is the same material on either side of die cut area 740. The release liner material outside the die cut area may be referred to as the outer release liner 750. The release liner material inside the die cut area may be referred to as the inner release liner 760. FIG. 19C shows outer release liner 750 removed to expose the underlying adhesive 115, and leaving inner release liner 760 which now becomes raised element 120. This embodiment allows unattached individual sheets to be easily transportable while protecting adhesive edges 1-1, 2-2, 3-3, and 4-4, as referenced in FIG. 3.

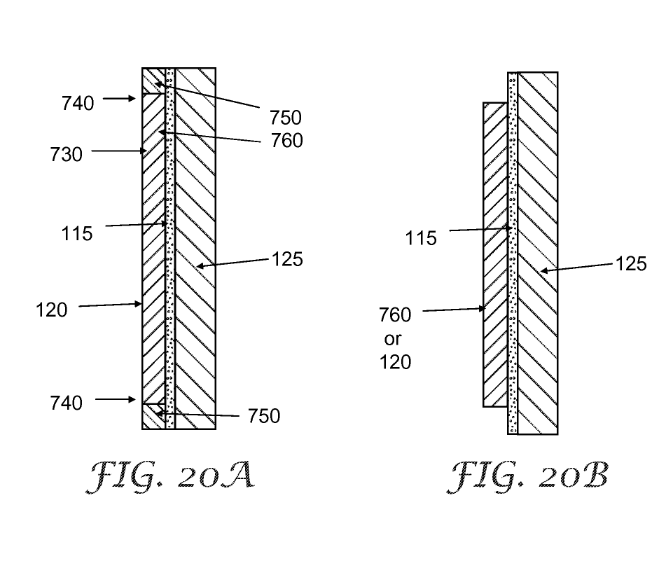

FIG. 20A is a sectional side view of FIGS. 19B showing release liner 730 with die cut area 740.

FIG. 20B is a sectional side view of FIG. 19C showing outer release liner 730 removed at die cut area 740, thus exposing adhesive edges 1-1, 2-2, 3-3, and 4-4, as referenced in FIG. 3, and attached to the adhesive is raised element 120, which was part of release liner 730.

In any embodiment described herein, the substrate or backing layer 125 should be formed of a material that is sufficiently stiff so that it will not curl when detaching a sheet from a stack, a release liner sheet or roll format, nor allow edges of the sheet to flex, drape or sag such that it will contact and grab onto the application surface when sliding the sheet across the surface into proper position. In addition, the substrate 125 should be formed of a material that is sufficiently flexible to allow the exposed adhesive edges to contact the application surface when securing the masking sheet in place by pressing against the adhesive regions edges with fingers. The substrate is generally somewhat deformable, and does not allow paint to creep under the sheets in areas where sheets are shingled or overlapped as shown in FIG. 17. Suitable examples of substrate materials include, but are not limited to, paper, synthetic plastic materials, metal foils, and combination thereof. The substrate may have a thickness of 0.0005 inch to about 0.10 inch. In certain embodiment, the sheet assemblies (i.e. the combination of the substrate, the adhesive, and the raised element(s)) may vary from about 1.0 inch to about 36 inches in width, to about 1 inch to about 36 inches in length, depending on the particular end use application.

The raised elements can be made from a variety of material. Suitable examples include applying ultraviolet (UV) curable or water based coatings, which would form the raised elements. Other suitable materials for the raised element include plastic, paper, or nonwoven materials, where the plastic, paper or nonwoven material is disposed on the pressure sensitive adhesive. Another suitable material for the raised element is tape, where the adhesive side of the tape is disposed on the pressure sensitive adhesive. In certain embodiments, the substrate may have a thickness of at least about 0.005 mm, at least about 0.01 mm, or at least about 0.02 mm, and a thickness of no greater than about 0.4 mm, no greater than about 0.35 mm, or no greater than about 0.3 mm. If the masking article includes more than one raised element per sheet, the spacing between one raised element and an adjacent raised element is generally no greater than about 5 centimeters.

Suitable pressure sensitive adhesives (PSA) are known to those skilled in the art. The adhesive may be, for example, rubber-based adhesive, acrylic-based adhesive, silicone-based adhesive, polyurethane adhesive, and combinations thereof, and may be solvent based, water based, or can be a solventless, hot melt adhesive. The adhesive may be a repositionable adhesive or a permanent adhesive.

Persons of ordinary skill in the art may appreciate that various changes and modifications may be made to the invention described above without deviating from the inventive concept. Thus, the scope of the present invention should not be limited to the structures described in this application, but only by the structures described by the language of the claims and the equivalents of those structures.

What is claimed is:

1. A masking article, comprising:
(a) a bendable backing layer having first and second opposed major surfaces;
(b) an adhesive arranged on at least a portion of at least one of the first and second major surfaces, wherein the adhesive has a thickness; and
(c) a raised element arranged on the same major surface as the adhesive, wherein the raised element extends beyond the thickness of the adhesive,
whereby the masking article can be moved along an application surface to a desired location without having the adhesive adhere to the application surface, and further wherein the masking article can be secured to the application surface by pressing the backing layer in the region opposite the adhesive, thereby forcing the adhesive into contact with the application surface to secure the masking article to the application surface at the desired location.
